(19) United States
(12) Patent Application Publication
(10) Pub. No.: US 2013/0076879 A1
(43) Pub. Date: Mar. 28, 2013

(54) ENDOSCOPIC IMAGE PROCESSING DEVICE, ENDOSCOPE APPARATUS, AND IMAGE PROCESSING METHOD

(71) Applicant: Seigo ON, Tokyo (JP)

(72) Inventor: Seigo ON, Tokyo (JP)

(21) Appl. No.: 13/615,507

(22) Filed: Sep. 13, 2012

(30) Foreign Application Priority Data
Sep. 26, 2011 (JP) 2011-208765

(51) Int. Cl. H04N 7/18

(52) U.S. Cl. 348/65; 348/E07.085

(57) ABSTRACT

An endoscopic image processing device includes an image acquisition section (A/D conversion section) that acquires a front image that corresponds to a front field of view and a side image that corresponds to a side field of view, and a chromatic-aberration-of-magnification correction section that performs a chromatic-aberration-of-magnification correction process on an observation optical system, the chromatic-aberration-of-magnification correction section determining whether a processing target image signal corresponds to the front field of view or the side field of view, and performing a front chromatic-aberration-of-magnification correction process as the chromatic-aberration-of-magnification correction process when the chromatic-aberration-of-magnification correction section has determined that the processing target image signal corresponds to the front field of view.

Japanese Patent Application No. 2011-208765 filed on Sep. 26, 2011, is hereby incorporated by reference in its entirety.

### BACKGROUND

The present invention relates to an endoscopic image processing device, an endoscope apparatus, an image processing method, and the like.

JP-A-2010-117665 discloses an optical system that is configured so that the observation state can be switched using a variable aperture between a state in which the front field of view and the side field of view can be observed at the same time, and a state in which only the front field of view can be observed. The state in which the front field of view and the side field of view can be observed at the same time is particularly effective for observing the back side of the folds of a large intestine using an endoscope, and may make it possible to find a lesion that is otherwise missed. FIG. 1 illustrates an example of an optical system that is configured so that the observation mode can be switched using a variable aperture between a state in which the front field of view and the side field of view can be observed at the same time, and a state in which only the front field of view can be observed.

### SUMMARY

According to one aspect of the invention, there is provided an endoscopic image processing device comprising:
an image acquisition section that acquires a front image that corresponds to a front field of view and a side image that corresponds to a side field of view; and
a chromatic-aberration-of-magnification correction section that performs a chromatic-aberration-of-magnification correction process on an observation optical system,
the chromatic-aberration-of-magnification correction section determining whether a processing target image signal corresponds to the front field of view or the side field of view, and performing a front chromatic-aberration-of-magnification correction process as the chromatic-aberration-of-magnification correction process when the chromatic-aberration-of-magnification correction section has determined that the processing target image signal corresponds to the front field of view.

According to another aspect of the invention, there is provided an endoscopic image processing device comprising:
an image acquisition section that acquires a front image that corresponds to a front field of view and a side image that corresponds to a side field of view; and
a chromatic-aberration-of-magnification correction section that performs a first chromatic-aberration-of-magnification correction process and a second chromatic-aberration-of-magnification correction process, the first chromatic-aberration-of-magnification correction process being performed on the front image, and the second chromatic-aberration-of-magnification correction process being performed on the side image.

According to another aspect of the invention, there is provided an endoscope apparatus comprising the above endoscopic image processing device.

According to another aspect of the invention, there is provided an image processing method comprising:
acquiring a front image that corresponds to a front field of view and a side image that corresponds to a side field of view;
determining whether a processing target image signal corresponds to the front field of view or the side field of view; and
performing a front chromatic-aberration-of-magnification correction process as a chromatic-aberration-of-magnification correction process on an observation optical system when it has been determined that the processing target image signal corresponds to the front field of view.

### BRIEF DESCRIPTION OF THE DRAWINGS

FIG. 1 illustrates a configuration example of a wide-angle imaging system used in one embodiment of the invention.

FIG. 2 illustrates an example of an image acquired using a wide-angle imaging system.

FIG. 3 illustrates a configuration example of an endoscope apparatus that includes an endoscopic image processing device according to one embodiment of the invention.

FIG. 4 illustrates a configuration example of a chromatic-aberration-of-magnification correction section.

FIG. 5 illustrates a configuration example of a switch section.

FIG. 6 illustrates an example of mask data that is stored as determination information.

FIG. 7 illustrates a configuration example of a front chromatic-aberration-of-magnification correction section.

FIG. 8 illustrates an example of parameters stored in a correction coefficient storage section.

FIG. 9 is a view illustrating the relationship between the square of an image height and an image height ratio.

FIG. 10 illustrates a configuration example of a front image height calculation section.

FIG. 11 is a view illustrating a bicubic interpolation method.

FIG. 12 illustrates a configuration example of a side chromatic-aberration-of-magnification correction section.

FIG. 13 illustrates a configuration example of a side image height calculation section.

FIG. 14 illustrates a configuration example of a blending section.

FIG. 15 is a view illustrating a boundary area correction process that enlarges a front area.

FIG. 16 is a view illustrating a boundary area correction process that enlarges a side area.

FIG. 17 illustrates another configuration example of an endoscope apparatus that includes an endoscopic image processing device according to the second embodiment.

FIG. 18 illustrates a configuration example of a Bayer array image sensor.

FIG. 19 illustrates a configuration example of a two-chip image sensor.

FIG. 20 illustrates an example when using a frame-sequential image sensor.

### DESCRIPTION OF EXEMPLARY EMBODIMENTS

According to one embodiment of the invention, there is provided an endoscopic image processing device comprising:
an image acquisition section that acquires a front image that corresponds to a front field of view and a side image that corresponds to a side field of view; and
a chromatic-aberration-of-magnification correction section that performs a chromatic-aberration-of-magnification correction process on an observation optical system,
the chromatic-aberration-of-magnification correction section determining whether a processing target image signal corresponds to the front field of view or the side field of view, and performing a front chromatic-aberration-of-magnification correction process as the chromatic-aberration-of-magnification correction process when the chromatic-aberration-of-magnification correction section has determined that the processing target image signal corresponds to the front field of view.

According to another embodiment of the invention, there is provided an endoscopic image processing device comprising:
an image acquisition section that acquires a front image that corresponds to a front field of view and a side image that corresponds to a side field of view; and
a chromatic-aberration-of-magnification correction section that performs a first chromatic-aberration-of-magnification correction process and a second chromatic-aberration-of-magnification correction process, the first chromatic-aberration-of-magnification correction process being performed on the front image, and the second chromatic-aberration-of-magnification correction process being performed on the side image.

This makes it possible to implement an endoscopic image processing device that performs a front-image chromatic-aberration-of-magnification correction process on the front image, and performs a side-image chromatic-aberration-of-magnification correction process on the side image.

According to another embodiment of the invention, there is provided an endoscope apparatus comprising the above endoscopic image processing device.

According to another embodiment of the invention, there is provided an image processing method comprising:
acquiring a front image that corresponds to a front field of view and a side image that corresponds to a side field of view;
determining whether a processing target image signal corresponds to the front field of view or the side field of view; and
performing a front chromatic-aberration-of-magnification correction process as a chromatic-aberration-of-magnification correction process on an observation optical system when it has been determined that the processing target image signal corresponds to the front field of view.

Exemplary embodiments of the invention are described below. Note that the following exemplary embodiments do not in any way limit the scope of the invention laid out in the claims. Note also that all of the elements of the following exemplary embodiments should not necessarily be taken as essential elements of the invention.

### 1. Method

A method employed in several embodiments of the invention is described below. The refractive index of a lens included in an optical system varies depending on the wavelength of light. Therefore, the focal length varies (i.e., the size of the image varies) depending on the wavelength of light even if the lens is the same. The above phenomenon is referred to as “chromatic aberration of magnification”. The image is blurred when a color shift occurs due to the chromatic aberration of magnification. Therefore, it is necessary to correct the chromatic aberration of magnification.

Several embodiments of the invention utilize an optical system that can observe the front field of view and the side field of view. Such an optical system may be implemented by utilizing a front observation optical system and a side observation optical system, for example. Alternatively, the observation area may be switched (changed) in time series using a single optical system. In such a case, since the conditions of the optical system differ between the case of observing the front field of view and the case of observing the side field of view, a chromatic-aberration-of-magnification correction process cannot be implemented using one series of parameters.

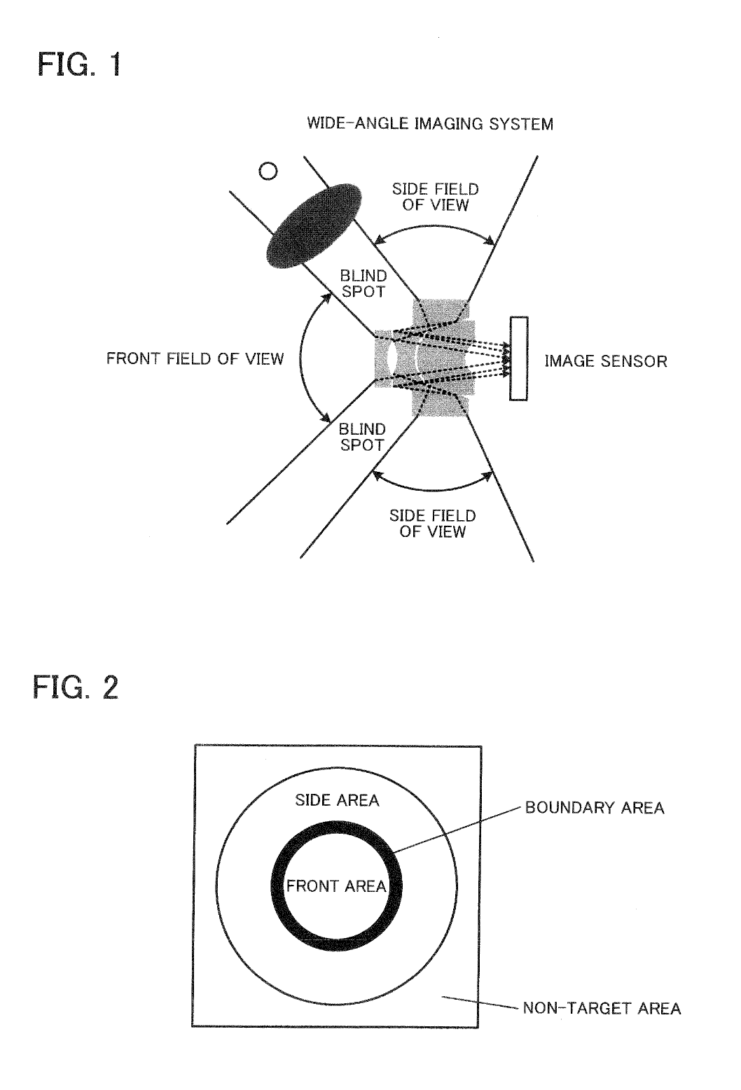

When using an optical system that is configured so that the front field of view and the side field of view can be imaged at the same time, a dark boundary area (see FIG. 2) may occur between the front area that corresponds to the front field of view and the side area that corresponds to the side field of view. In particular, since the intensity of light decreases (gradation occurs) in an area around the front field of view due to the lens of the refracting system, the boundary area is formed as a black strip-shaped area that is connected to the gradation area. The black strip-shaped area occurs due to a blind spot between the front field of view and the side field of view (see FIG. 1), or occurs when the intensity of light is insufficient in the edge (peripheral) area of the front field of view. When observing a large intestine using an endoscope apparatus, for example, the boundary area may be erroneously determined to be folds even if no folds are present in the boundary area.

In order to deal with the above problem, several aspects of the invention employ the following method. Specifically, the chromatic-aberration-of-magnification correction process is performed on the front area and the side area using different parameters. This makes it possible to deal with a difference in the conditions of the optical system between the case of observing the front field of view and the case of observing the side field of view. An additional process includes reducing the boundary area by performing an enlargement process on at least one of the front area and the side area that have been subjected to the chromatic-aberration-of-magnification correction process, and then performing a blending process. For example, the front area may be outwardly enlarged, and blended with the side area. This makes it possible to reduce the boundary area, and ensure smooth observation, for example.

A first embodiment illustrates an example of the chromatic-aberration-of-magnification correction process performed when using a three-chip image sensor. A boundary area correction process as an additional process is also described in connection with the first embodiment. A second embodiment illustrates an example of the chromatic-aberration-of-magnification correction process performed when using a single-chip or two-chip image sensor, or when using a frame sequential method (the boundary area correction process is performed in the same manner as in the first embodiment). An optical axis shift correction process (modification) is also described in connection with the second embodiment.

### 2. First Embodiment

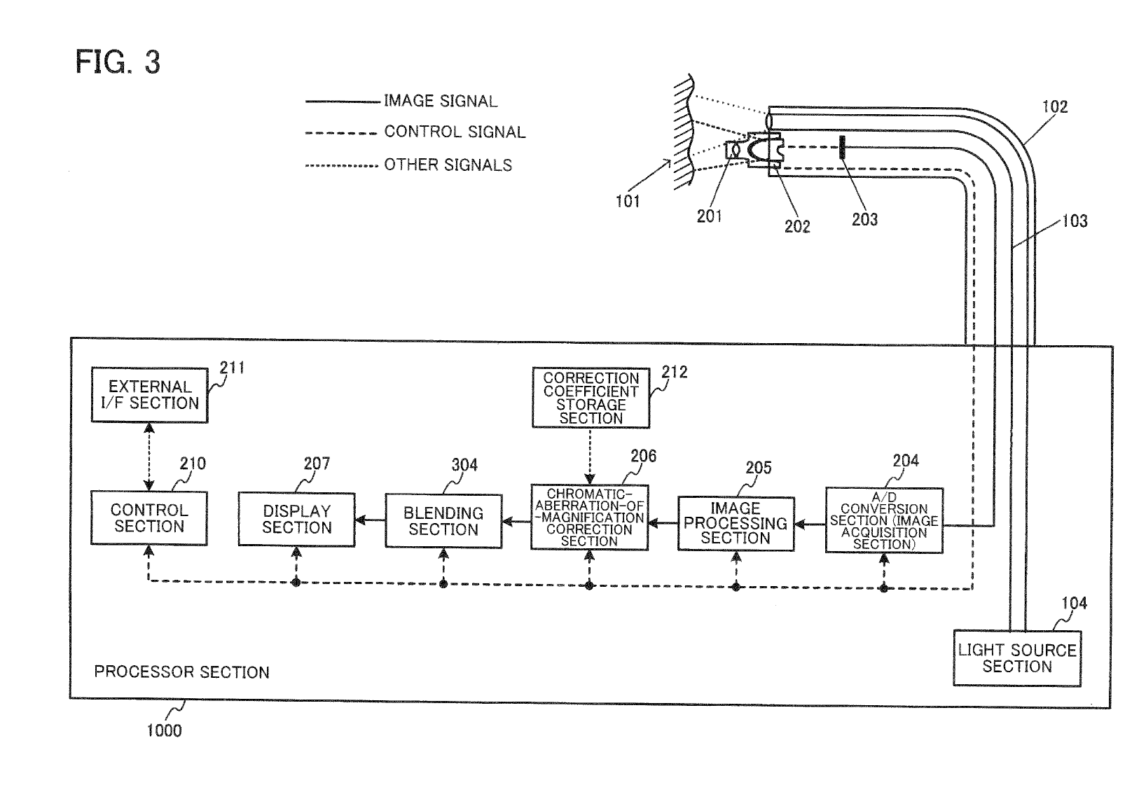

FIG. 3 illustrates a configuration example of an endoscope apparatus that includes an endoscopic image processing device according to the first embodiment. The endoscope apparatus illustrated in FIG. 3 includes an insertion section 102, a light guide 103, a light source section 104, a front observation optical system 201, a side observation optical system 202, an image sensor 203, an A/D conversion section 204, an image processing section 205, a chromatic-aberration-of-magnification correction section 206, a display section 207, a control section 210, an external I/F section 211, a blending section 304, and a correction coefficient storage section 212. A processor section 1000 includes the light source section 104, the A/D conversion section 204, the image processing section 205, the chromatic-aberration-of-magnification correction section 206, the display section 207, the control section 210, the external I/F section 211, the blending section 304, and the correction coefficient storage section 212. Note that the processor section 1000 is not limited to the configuration illustrated in FIG. 3. Various modifications may be made, such as omitting some of the elements illustrated in FIG. 3 or adding other elements.

Since the endoscope apparatus is used for an endoscopic examination or treatment, the insertion section 102 has an elongated shape and can be curved so that the insertion section 102 can be inserted into a body. Light emitted from the light source section 104 is applied to an object 101 via the light guide 103 that can be curved. The front observation optical system 201 and the side observation optical system 202 are disposed at the end of the insertion section 102. The endoscopic apparatus includes the front observation optical system 201 that observes the front field of view, and the side observation optical system 202 that observes the side field of view, so that the front field of view and the side field of view can be observed at the same time. Note that the configuration of the optical system is not limited thereto. For example, a single optical system may be used, and the observation target may be changed in time series (i.e., the front field of view is observed at one timing, and the side field of view is observed at another timing). Reflected light from the object 101 within the front field of view forms an image on the image sensor 203 via the front observation optical system 201, and reflected light from the object 101 within the side field of view forms an image on the image sensor 203 via the side observation optical system 202. Analog image signals output from the image sensor 203 are transmitted to the A/D conversion section 204.

The insertion section 102 can be removed from the processor section 1000. The doctor selects the desired scope from a plurality of scopes (insertion sections 102) depending on the objective of medical examination, attaches the selected scope to the processor section 1000, and performs a medical examination or treatment.

The A/D conversion section 204 (image acquisition section) is connected to the display section 207 via the image processing section 205, the chromatic-aberration-of-magnification correction section 206, and the blending section 304. The control section 210 is bidirectionally connected to the A/D conversion section 204, the image processing section 205, the chromatic-aberration-of-magnification correction section 206, the blending section 304, the display section 207, and the external I/F section 211.

The A/D conversion section 204 converts the analog image signals output from the image sensor 203 into digital image signals (hereinafter referred to as “image signals”), and transmits the image signals to the image processing section 205.

The image processing section 205 performs known image processing on the image signals input from the A/D conversion section 204 under control of the control section 210. The image processing section 205 performs a white balance process, a color management process, a grayscale transformation process, and the like. The image processing section 205 transmits the resulting image signals (RGB signals) to the chromatic-aberration-of-magnification correction section 206.

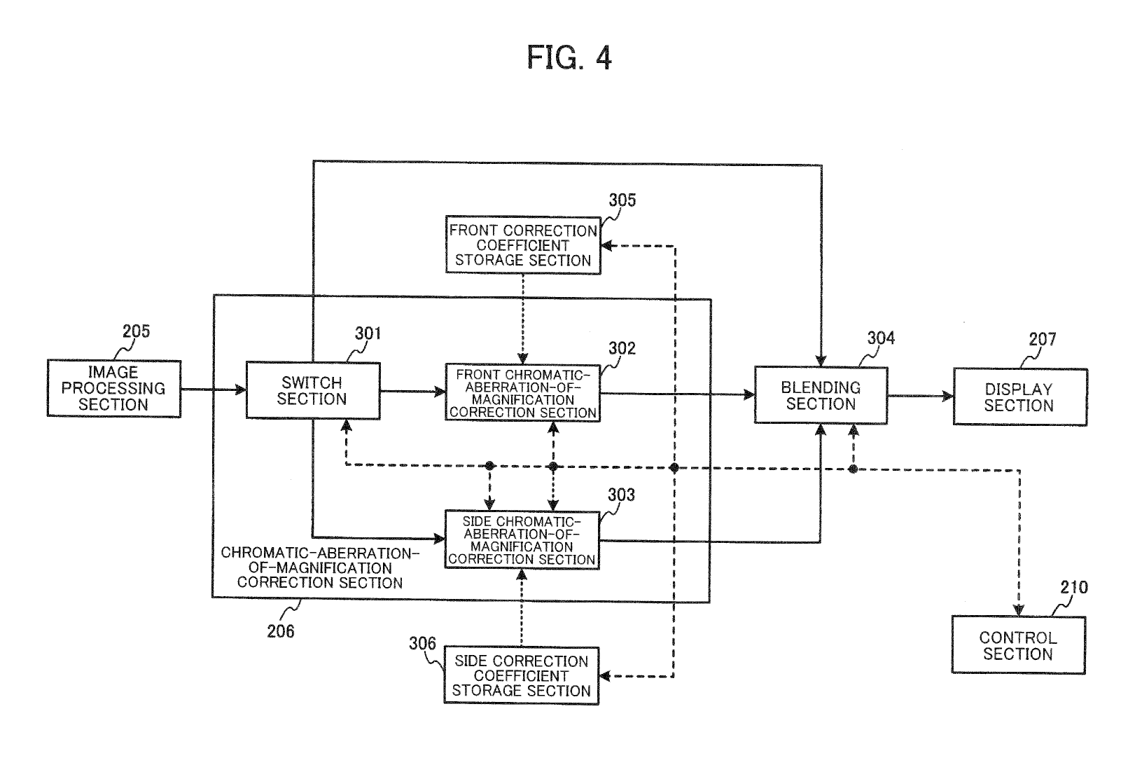

FIG. 4 illustrates an example of the configuration of the chromatic-aberration-of-magnification correction section 206. The chromatic-aberration-of-magnification correction section 206 includes a switch section 301, a front chromatic-aberration-of-magnification correction section 302, and a side chromatic-aberration-of-magnification correction section 303. A front correction coefficient storage section 305 and a side correction coefficient storage section 306 are included in the correction coefficient storage section 212 (not illustrated in FIG. 4). The image processing section 205 is connected to the front chromatic-aberration-of-magnification correction section 302, the side chromatic-aberration-of-magnification correction section 303, and the blending section 304 via the switch section 301. The front chromatic-aberration-of-magnification correction section 302 is connected to the display section 207 via the blending section 304. The side chromatic-aberration-of-magnification correction section 303 is connected to the blending section 304. The front correction coefficient storage section 305 is connected to the front chromatic-aberration-of-magnification correction section 302. The side correction coefficient storage section 306 is connected to the side chromatic-aberration-of-magnification correction section 303. The control section 210 is bidirectionally connected to the switch section 301, the front chromatic-aberration-of-magnification correction section 302, the side chromatic-aberration-of-magnification correction section 303, the blending section 304, the front correction coefficient storage section 305, and the side correction coefficient storage section 306.

The RGB signals output from the image processing section 205 are transmitted to the switch section 301 under control of the control section 210.

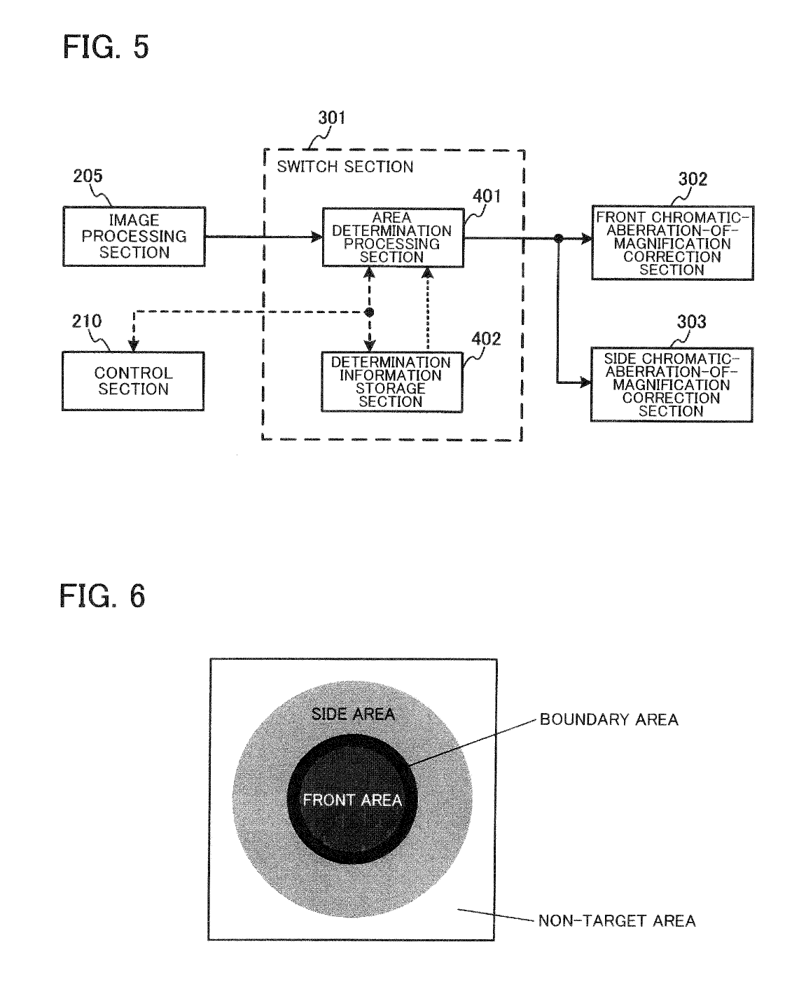

FIG. 5 illustrates an example of the configuration of the switch section 301. The switch section 301 includes an area determination section 401 and a determination information storage section 402. The image processing section 205 is connected to the front chromatic-aberration-of-magnification correction section 302 via the area determination section 401. The determination information storage section 402 is connected to the area determination section 401. The control section 210 is bidirectionally connected to the area determination section 401 and the determination information storage section 402. The area determination section 401 determines whether the image signals (RGB signals) output from the image processing section 205 correspond to the front area or the side area under control of the control section 210. As illustrated in FIG. 2, the image signals correspond to the front area (circular center area), the doughnut-shaped side area that surrounds the front area, the boundary area (blind spot) that is positioned between the front area and the side area, or a non-target area that is positioned on the outer side of the side area (i.e., an area other than the captured image). As illustrated in FIG. 6, mask data that specifies the front area, the side area, the boundary area, and the non-target area is stored in the determination information storage section 402 in advance. The area determination section 401 extracts the mask data from the determination information storage section 402, and performs an area determination process on the image signals output from the image processing section 205 on a pixel basis. When the area determination section 401 has determined that the image signal corresponds to the front area, the area determination section 401 transmits the image signal to the front chromatic-aberration-of-magnification correction section 302. When the area determination section 401 has determined that the image signal corresponds to the side area, the area determination section 401 transmits the image signal to the side chromatic-aberration-of-magnification correction section 303. When the area determination section 401 has determined that the image signal corresponds to an area other than the front area and the side area, the area determination section 401 transmits the image signal to the blending section 304. The area determination section 401 also transmits the mask data to the blending section 304.

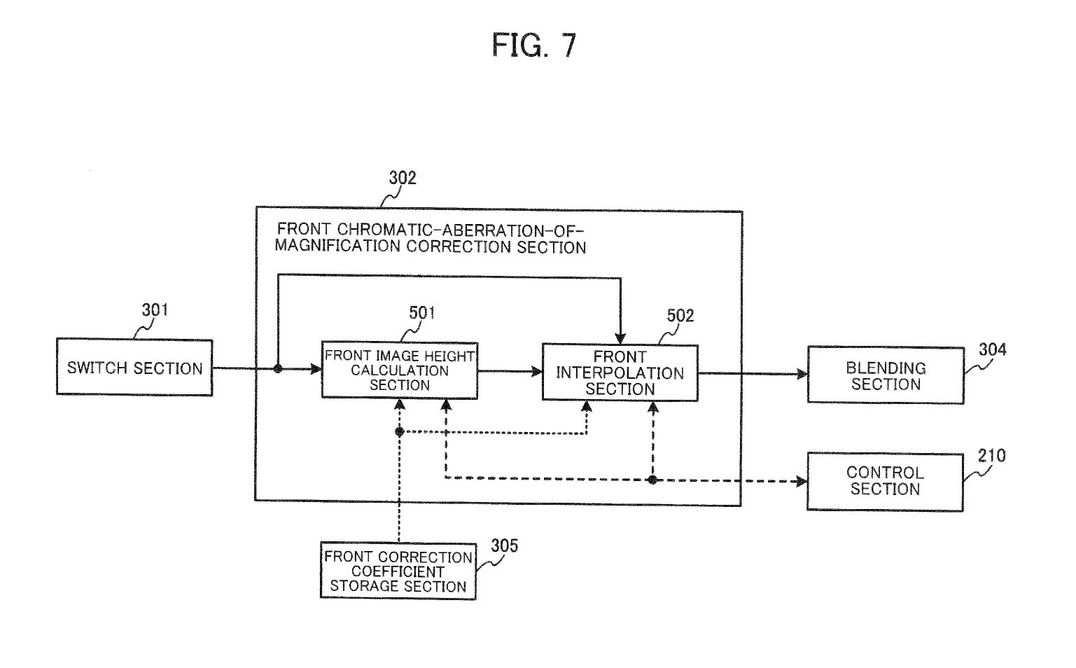

FIG. 7 illustrates an example of the configuration of the front chromatic-aberration-of-magnification correction section 302. The front chromatic-aberration-of-magnification correction section 302 includes a front image height calculation section 501 and a front interpolation section 502. The switch section 301 is connected to the blending section 304 via the front image height calculation section 501 and the front interpolation section 502. The switch section 301 is connected to the front interpolation section 502. The front correction coefficient storage section 305 is connected to the front image height calculation section 501 and the front interpolation section 502. The control section 210 is bidirectionally connected to the front image height calculation section 501 and the front interpolation section 502.

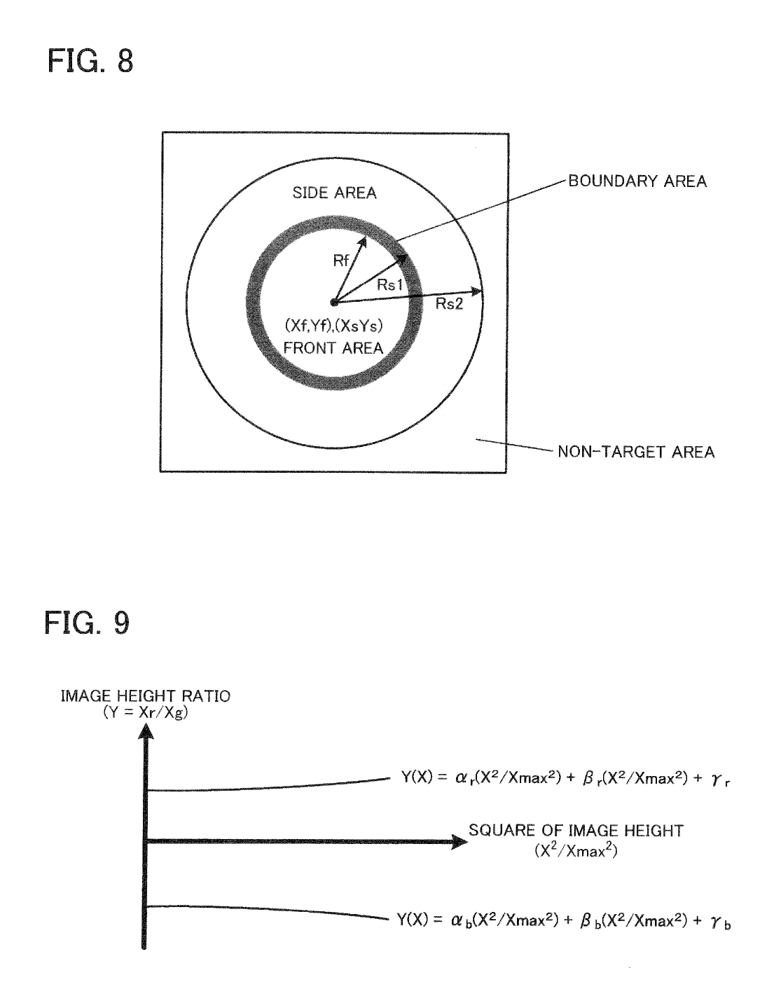

In the first embodiment, the real image height of the R image signal and the real image height of the B image signal is calculated on a pixel basis based on the ratio of the image height of the R image signal to the image height of the G image signal and the ratio of the image height of the B image signal to the image height of the G image signal, and the magnification shift amount is corrected by an interpolation process. The coordinates (Xf, Yf) of the center point (i.e., a pixel that corresponds to the optical center of the front objective lens optical system) of the front area, and the radius Rf of a circle that corresponds to the front area (see FIG. 8) are stored in the front correction coefficient storage section 305 in advance. The coordinates (Xs, Ys) of the center point (i.e., a pixel that corresponds to the optical center of the side objective lens optical system) of the side area, and the inner radius Rs1 and the outer radius Rs2 of a doughnut-like shape that corresponds to the side area are stored in the side correction coefficient storage section 306 in advance. The following description is given taking an example in which the center point of the front area and the center point of the side area correspond to an identical pixel, and have identical coordinates. Note that the configuration is not limited thereto.

FIG. 9 illustrates an example of a graph of the ratio of the image height of the R image signal to the image height of the G image signal and the ratio of the image height of the B image signal to the image height of the G image signal The horizontal axis corresponds to the square Q of the image height of the G image signal, and the vertical axis corresponds to the ratio Y of the image height of the R image signal and the ratio Y of the image height of the B image signal. The square of the image height of the G image signal is calculated by the following expression (1), the ratio Y(R) of the image height of the R image signal is calculated by the following expression (2), and the ratio Y(B) of the image height of the B image signal is calculated by the following expression (3).

Q=Xg²/Xmax² (1)

Y(R)=Xr/Xg (2)

Y(B)=Xb/Xg (3)

Note that Xr is the image height of the R image signal, Xb is the image of the B image signal, Xg is the image height of the G image signal, and Xmax is the maximum image height of the G image signal. In the first embodiment, Xmax corresponds to the radius Rf of a circle that corresponds to the front area (see FIG. 8).

The ratio Y(R) of the image height of the R image signal and the ratio Y(B) of the image height of the B image signal respectively have a relationship shown by the following expression (4) or (5) with the square Q of the image height of the G image signal.

Y(R)=αᵣQ²+βᵣQ+γᵣ (4)

Y(B)=α_{b}Q²+β_{b}Q+γ_{b} (5)

Note that αᵣ, βᵣ, and γᵣ are image height ratio coefficients that correspond to the R image signal, and α_{b}, β_{b}, and γ_{b} are image height ratio coefficients that correspond to the B image signal. These coefficients are designed taking account of the chromatic aberration of magnification of the front observation optical system that images the front area, and stored in the front correction coefficient storage section 305 in advance.

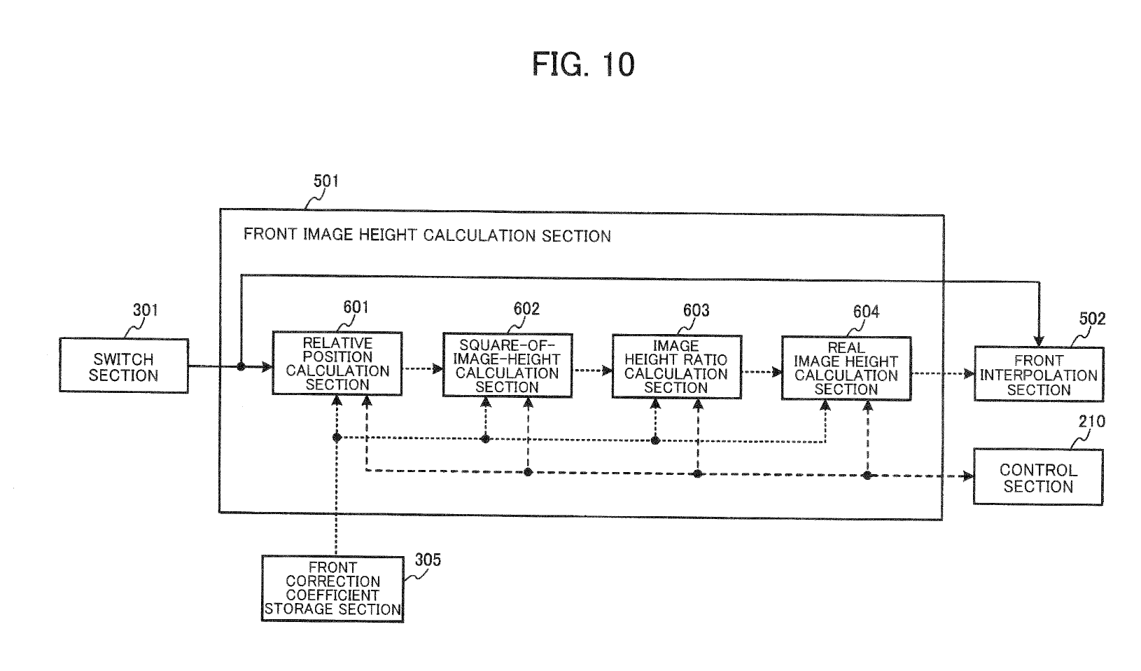

The front image height calculation section 501 detects the image height ratio coefficients from the front correction coefficient storage section 305 on a pixel basis using pixel position information about the image signal that corresponds to the front area to convert the image height ratio, and calculates the real image height (converted coordinate values) of the R image signal and the real image height (converted coordinate values) of the B image signal from the image height ratio under control of the control section 210. FIG. 10 illustrates an example of the configuration of the front image height calculation section 501. The front image height calculation section 501 includes a relative position calculation section 601, a square-of-image-height calculation section 602, an image height ratio calculation section 603, and a real image height calculation section 604. The switch section 301 is connected to the front interpolation section 502 via the relative position calculation section 601 the square-of-image-height calculation section 602, the image height ratio calculation section 603, and the real image height calculation section 604. The switch section 301 is connected to the front interpolation section 502. The front correction coefficient storage section 305 is connected to the relative position calculation section 601, the square-of-image-height calculation section 602, the image height ratio calculation section 603, and the real image height calculation section 604. The control section 210 is bidirectionally connected to the relative position calculation section 601, the square-of-image-height calculation section 602, the image height ratio calculation section 603, and the real image height calculation section 604.

The relative position calculation section 601 extracts the coordinates (Xf, Yf) of the center point (i.e.. a pixel that corresponds to the optical center of the front objective lens optical system) of the front area from the front correction coefficient storage section 305, calculates the relative position (posX, posY) of an attention pixel with respect to the optical center using the following expression (6), and transmits the relative position (posX, posY) to the square-of-image-height calculation section 602 under control of the control section 210.

posX=i−Xf

posY=j−Xf (6)

Note that i is the horizontal coordinate value of the attention pixel, and j is the vertical coordinate value of attention pixel.

The square-of-image-height calculation section 602 calculates the square Q of the image height of the G image signal (see the expression (1)) from the relative position (posX, posY) of the attention pixel and the radius Rf of a circle that corresponds to the front area (stored in the front correction coefficient storage section 305), and transmits the square Q to the image height ratio calculation section 603 under control of the control section 210. The image height ratio calculation section 603 extracts the image height ratio coefficients from the front correction coefficient storage section 305, calculates the ratio Y(R) of the image height of the R image signal using the expression (4), calculates the ratio Y(B) of the image height of the B image signal using the expression (5), and transmits the ratio Y(R) and the ratio Y(B) to the real image height calculation section 604 under control of the control section 210. The real image height calculation section 604 extracts the coordinates (Xf, Yf) of the center point (i.e., a pixel that corresponds to the optical center of the front objective lens optical system) of the front area from the front correction coefficient storage section 305, and calculates the converted coordinate values of the R image signal and the B image signal of the attention pixel using the following expressions (7) and (8).

RealX(R)=Y(R)×posX+Xf

RealY(R)=Y(R)×posY+Yf (7)

RealX(B)=Y(B)×posX+Xf

RealY(B)=Y(B)×posY+Yf (8)

Note that RealX(R) is the converted horizontal coordinate value of the R image signal of the attention pixel, RealY(R) is the converted vertical coordinate value of the R image signal of the attention pixel, RealX(B) is the converted horizontal coordinate value of the B image signal of the attention pixel, and RealY(B) is the converted vertical coordinate value of the B image signal of the attention pixel.

Y(R) is the ratio of the image height of the R image signal to the image height of the G image signal, and Y(B) is the ratio of the image height of the B image signal to the image height of the G image signal (see the expressions (2) and (3)). posX and posY are the coordinates of the G image signal when the coordinates that correspond to the optical center indicate the origin (i.e., posX and posY correspond to the image height of the G image signal). Therefore, since the ratio Y(R) or Y(B) is multiplied by the image height of the G image signal in the first term on the right side of the expressions (7) and (8), a value that corresponds to the image height of the R image signal or the B image signal is obtained. The coordinates are transformed by the second term on the right side, and returned from the coordinate system in which the origin corresponds to the optical center to a reference coordinate system (e.g., a coordinate system in which the upper left point of the image is the origin). Specifically, the converted coordinate value is a coordinate value that corresponds to the image height of the R image signal or the B image signal when reference coordinates indicate the origin.

The real image height calculation section 604 transmits converted coordinate value information about the R image signal and the B image signal of the attention pixel to the front interpolation section 502.

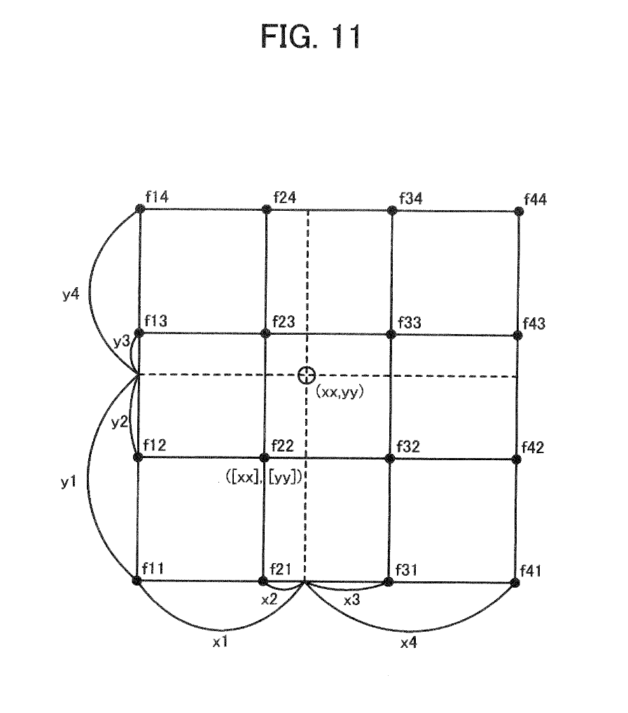

The front interpolation section 502 performs an interpolation process by a known bicubic interpolation method on a pixel basis using the converted coordinate value information about the R image signal and the B image signal of the attention pixel that has been input from the front image height calculation section 501 under control of the control section 210. More specifically, the front interpolation section 502 calculates the pixel value V at the desired position (xx, yy) (i.e., (RealX(R), RealY(R)) (R image signal) or (RealX(B),RealY(B)) (B image signal)) by the following expression (9) using the pixel values f11, f12, . . . , and f44 at sixteen peripheral points (i.e., the pixel values of the R image signals at sixteen points around the attention pixel, or the pixel values of the B image signals at sixteen points around the attention pixel) (see FIG. 11).

$$V ( xx , yy ) = ( h ( x 1 ) h ( x 2 ) h ( x 3 ) h ( x 4 ) ) ( \begin{matrix}f 11 & f 12 & f 13 & f 14 \\ f 21 & f 22 & f 23 & f 24 \\ f 31 & f 32 & f 33 & f 34 \\ f 41 & f 42 & f 43 & f 44\end{matrix} ) ( \begin{matrix}h ( y 1 ) \\ h ( y 2 ) \\ h ( y 3 ) \\ h ( y 4 )\end{matrix} ) \qquad ( 9 )$$

Note that each value of the expression (9) is shown by the following expressions (10) and (11) when [xx] is the maximum integer that does not exceed xx.

x1=1+xx−[xx]

x2=xx−[xx]

x3=[xx]+1−xx

x4=[xx]+2−xx

y1=1+yy−[yy]

y2=yy−[yy]

y3=[yy]+1−yy

y4=[yy]+2−yy (10)

h(t)=sin(πt)/πt (11)

The front interpolation section 502 transmits the R image signal and the B image signal obtained by the interpolation process to the blending section 304.

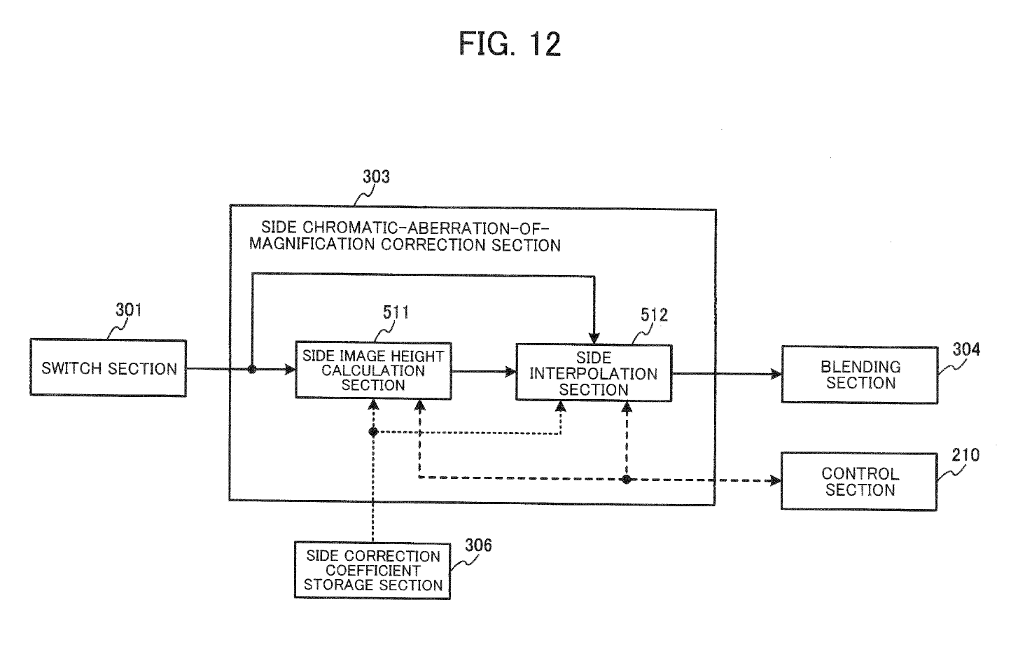

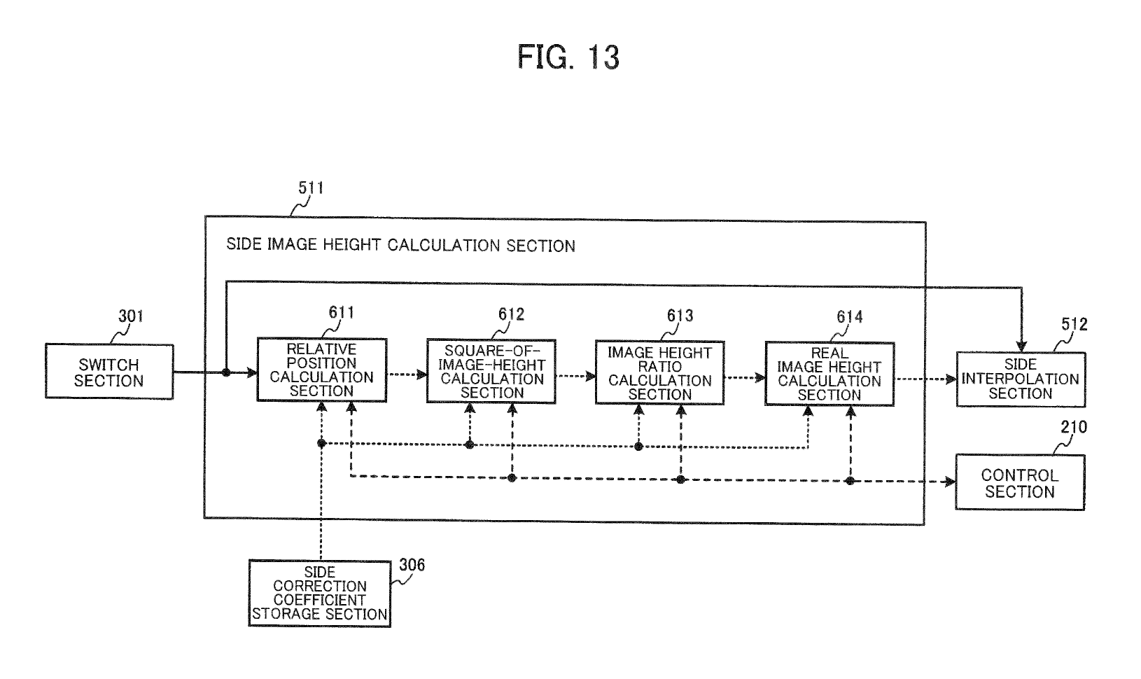

FIG. 12 illustrates an example of the configuration of the side chromatic-aberration-of-magnification correction section 303, and FIG. 13 illustrates an example of the configuration of the side image height calculation section 511. The side chromatic-aberration-of-magnification correction section 303 and the side image height calculation section 511 correct the chromatic aberration of magnification of the side area illustrated in FIG. 2. The side chromatic-aberration-of-magnification correction section 303 is configured in the same manner as the front chromatic-aberration-of-magnification correction section 302 illustrated in FIG. 7, and the side image height calculation section 511 is configured in the same manner as the front image height calculation section 501 illustrated in FIG. 10. The side chromatic-aberration-of-magnification correction section 303 performs a process similar to that performed by the front chromatic-aberration-of-magnification correction section 302, and the side image height calculation section 511 performs a process similar to that performed by the front image height calculation section 501.

The expressions (1) to (3) are similarly applied, except that Xmax in the expression (1) corresponds to Rs2 in FIG. 8 instead of Rf in FIG. 8. This is because the maximum image height is used as Xmax. The values used as the correction coefficients αᵣ, βᵣ, γᵣ, α_{b}, β_{b}, and γ_{b} in the expressions (4) and (5) differ from the values used for the front area. Specifically, since the optical system used to observe the front field of view normally differs from the optical system used to observe the side field of view, and the correction coefficients are determined by the design of the optical system, identical values cannot be used for the front area and the side area. Xs and Ys are used for the expressions (6) to (8) instead of Xf and Yf. This is because it is necessary to calculate the image height using the coordinates that correspond to the optical center of the optical system as the reference point (e.g., origin), and the optical system used to observe the front field of view and the optical system used to observe the side field of view normally differ in coordinates that correspond to the optical center.

The blending section 304 blends the image signals that correspond to the front area and have been acquired from the front chromatic-aberration-of-magnification correction section 302 and the image signals that correspond to the side area and have been acquired from the side chromatic-aberration-of-magnification correction section 303 using the mask data output from the switch section 301, and transmits the resulting image signals to the display section 207 under control of the control section 210.

In the first embodiment, the chromatic-aberration-of-magnification correction process is performed after performing known image signal processing on the image signals output from the A/D conversion section 204. Note that the configuration is not limited thereto. For example, known image signal processing may be performed after performing the chromatic-aberration-of-magnification correction process on the RGB image signals output from the A/D conversion section 204.

Although an example in which image signal processing is implemented by hardware has been described above, the configuration is not limited thereto. For example, the image signal obtained by the A/D conversion process may be recorded in a recording medium (e.g., memory card) as RAW data, and imaging information (e.g., AGC sensitivity and whit balance coefficient) from the control section 210 may be recorded in the recording medium as header information. A computer may be caused to execute an image signal processing program (software) to read and process the information recorded in the recording medium. The information may be transferred from the imaging section to the computer via a communication channel or the like instead of using the recording medium.

According to the first embodiment, the endoscopic image processing device includes the image acquisition section (A/D conversion section 204) that acquires a front image that corresponds to the front field of view and a side image that corresponds to the side field of view, and the chromatic-aberration-of-magnification correction section 206 that performs the chromatic-aberration-of-magnification correction process on the observation optical system (see FIG. 3). The chromatic-aberration-of-magnification correction section 206 determines whether the processing target image signal corresponds to the front field of view or the side field of view. When the chromatic-aberration-of-magnification correction section 206 has determined that the processing target image signal corresponds to the front field of view, the chromatic-aberration-of-magnification correction section 206 performs the front chromatic-aberration-of-magnification correction process as the chromatic-aberration-of-magnification correction process.

The endoscope apparatus includes the front observation optical system that observes the front field of view, and the side observation optical system that observes the side field of view (see FIG. 1). Note that the configuration is not limited thereto. For example, the endoscope apparatus may acquire the front image and the side image in time series using a single optical system.

The above configuration makes it possible to determine whether the processing target image signal corresponds to the front field of view or the side field of view, and perform the front chromatic-aberration-of-magnification correction process when it has been determined that the processing target image signal corresponds to the front field of view. The conditions of the optical system differ between the case of observing the front field of view and the case of observing the side field of view irrespective of whether the endoscope apparatus includes the front observation optical system and the side observation optical system, or acquires the front image and the side image in time series using a single optical system. Since the degree of chromatic aberration of magnification is determined by the design of the optical system, it is necessary to change the parameters corresponding to a change in the conditions of the optical system. Therefore, it is desirable to determine whether the processing target image signal corresponds to the front field of view or the side field of view, and perform the front chromatic-aberration-of-magnification correction process using the parameters for the front field of view when it has been determined that the processing target image signal corresponds to the front field of view in order to perform the chromatic-aberration-of-magnification correction process using appropriate parameters.

The chromatic-aberration-of-magnification correction section may perform the side chromatic-aberration-of-magnification correction process as the chromatic-aberration-of-magnification correction process when the chromatic-aberration-of-magnification correction section has determined that the processing target image signal corresponds to the side field of view.

This makes it possible to perform an appropriate chromatic-aberration-of-magnification correction process on the side area in addition to the front area. The side chromatic-aberration-of-magnification correction process is performed using values that differ from those used when performing the front chromatic-aberration-of-magnification correction process as the correction coefficients. More specifically, the side chromatic-aberration-of-magnification correction process is performed using values that differ from those used when performing the front chromatic-aberration-of-magnification correction process as the correction coefficients αᵣ, βᵣ, γᵣ, α_{b}, β_{b}, and γ_{b} (see the expressions (4) and (5)), and Xs and Ys are used for the expressions (6) to (8) instead of Xf and Yf.

The image acquisition section (e.g., A/D conversion section 204) may acquire the image signals that form the front image and the side image as a single image. The chromatic-aberration-of-magnification correction section 206 may include the determination information storage section 402 (see FIG. 5) that stores the determination information used to determine whether the processing target image signal corresponds to the front field of view or the side field of view within the acquired single image.

The image signals that form the front image and the side image as a single image may be image signals that correspond to the image illustrated in FIG. 2, for example.

This makes it possible to acquire the image illustrated in FIG. 2. and determine whether the processing target image signal corresponds to the front field of view or the side field of view using the determination information. Since the front image and the side image are formed as a single image in a way determined by the design of the optical system and the like, the determination information can he determined in advance. Therefore, whether the processing target image signal corresponds to the front field of view or the side field of view can be easily determined by providing the determination information storage section 402, and storing the determination information determined in advance.

The endoscopic image processing device may include a boundary area correction section that performs a correction process that reduces the boundary area that forms the boundary between the front area and the side area, the front area being an area that corresponds to the front field of view within the single image, and the side area being an area that corresponds to the side field of view within the single image.

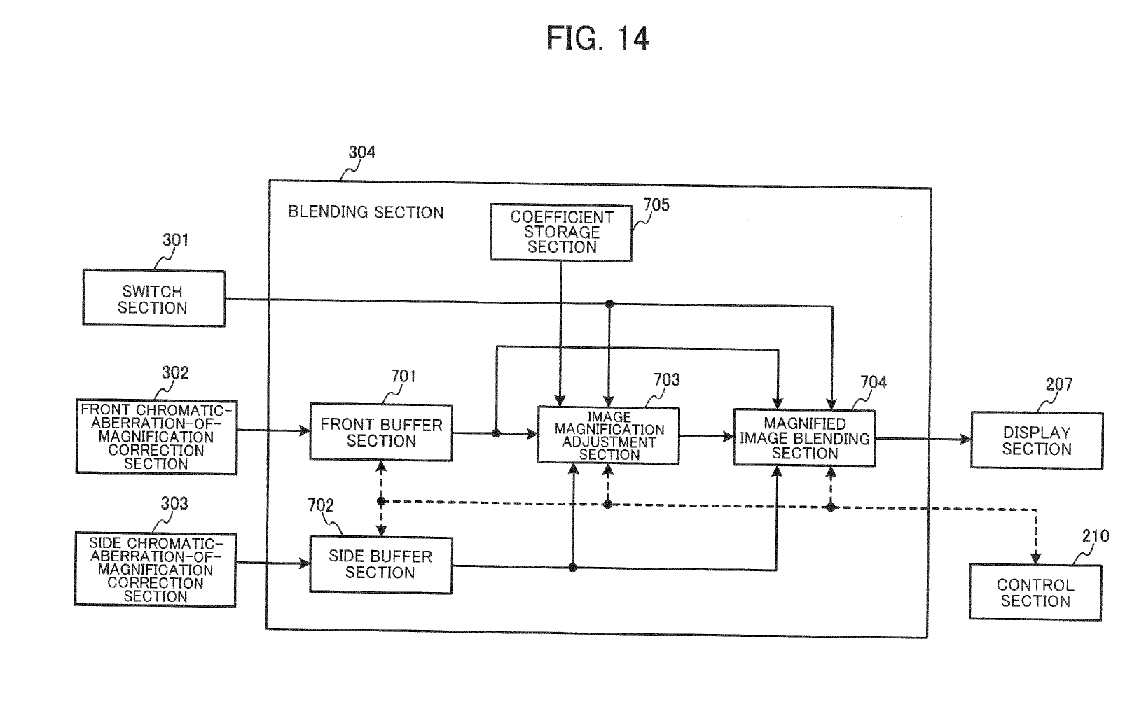

The boundary area correction section corresponds to the blending section 304 illustrated in FIG. 3. The blending section 304 performs a blending process that blends the front image and the side image subjected to the chromatic-aberration-of-magnification correction process. The blending process may include a correction process that reduces the boundary area. Specifically, the boundary area correction section may be implemented by the blending section 304 that also performs a correction process that reduces the boundary area. In this case, the boundary area correction section is configured as illustrated in FIG. 14, for example.

This makes it possible to reduce the boundary area. The correction process that reduces the boundary area may include a process that reduces the area of the boundary area, and a process that removes (eliminates) the boundary area (i.e., sets the area of the boundary area to zero). The boundary area occurs due to a blind spot between the front field of view and the side field of view, or occurs when the intensity of light is insufficient in the edge (peripheral) area of the front field of view. The boundary area hinders observation. In particular, the boundary area may be erroneously determined to be folds when observing a large intestine or the like using an endoscope apparatus. It is possible to ensure smooth observation by reducing the boundary area.

A case where the blending section 304 also performs the boundary area correction process is described below. FIG. 14 illustrates an example of the configuration of the blending section 304 when the blending section 304 also performs the boundary area correction process. As illustrated in FIG. 14, the blending section 304 includes a front buffer section 701, a side buffer section 702, an image magnification adjustment section 703, a magnified image blending section 704, and a coefficient storage section 705. The front chromatic-aberration-of-magnification correction section 302 is connected to the display section 207 via the front buffer section 701, the image magnification adjustment section 703, and the magnified image blending section 704. The side chromatic-aberration-of-magnification correction section 303 is connected to the side buffer section 702. The switch section 301 is connected to the image magnification adjustment section 703 and the magnified image blending section 704. The front buffer section 701 is connected to the magnified image blending section 704. The control section 210 is bidirectionally connected to the front buffer section 701, the side buffer section 702, the image magnification adjustment section 703, and the magnified image blending section 704.

The image signals that correspond to the front area and have been acquired from the front chromatic-aberration-of-magnification correction section 302 are stored in the front buffer section 701. The image signals that correspond to the side area and have been acquired from the side chromatic-aberration-of-magnification correction section 303 are stored in the side buffer section 702. A captured image in which the front field of view and the side field of view can be observed at the same time has a configuration in which the front field of view is positioned in the center area, the side field of view is positioned around the front field of view in the shape of a doughnut, and the boundary area (blind spot) is formed between the front field of view and the side field of view. Since the intensity of light decreases (gradation occurs) in an area around the front field of view due to the lens of the refracting system, the boundary area is formed as a black strip-shaped area that is connected to the gradation area. Since the black strip-shaped area hinders diagnosis performed by the doctor, it is necessary to reduce the black strip-shaped area to as small an area as possible.

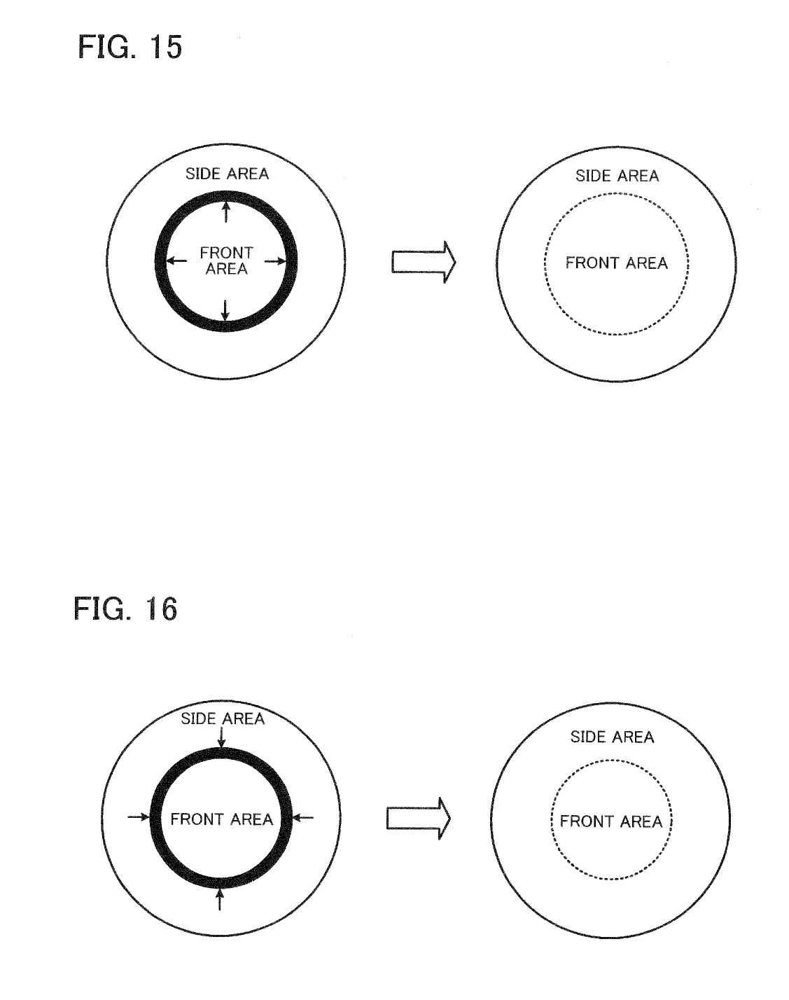

In the first embodiment, the display area of the black strip-shaped area is reduced by outwardly enlarging the front area illustrated in FIG. 15 around the optical axis. In this case, the image signals that correspond to the front area are transmitted from the front buffer section 701 to the image magnification adjustment section 703 under control of the control section 210. The image magnification adjustment section 703 extracts the mask data and a given adjustment magnification coefficient respectively from the switch section 301 and the coefficient storage section 705, magnifies (enlarges) the image signals that correspond to the front area by a known scaling process, and transmits the resulting image signals to the magnified image blending section 704 under control of the control section 210. The adjustment magnification coefficient is determined (designed) in advance based on the boundary area (blind spot) between the front field of view and the side field of view and the gradation characteristics, and stored in the coefficient storage section 705. The side buffer section 702 transmits the image signals that correspond to the side area to the magnified image blending section 704 under control of the control section 210. The magnified image blending section 704 blends the image signals that correspond to the front area and have been acquired from the image magnification adjustment section 703 and the image signals that correspond to the side area and have been acquired from the side buffer section 702 using the mask data output (extracted) from the switch section 301 under control of the control section 210. The display area of the black strip-shaped area can be reduced by thus magnifying (enlarging) the image signals that correspond to the front area (see FIG. 15).

Note that the image signals that correspond to the side area may be magnified using a given adjustment magnification coefficient (see FIG. 16), and blended with the image signals that correspond to the front area. Alternatively, the user may select the magnification target area via the external I/F section 211 under control of the control section 210.

This makes it possible to reduce stress on the doctor during diagnosis due to the black strip-shaped area.

The blending section 304 that also performs the boundary area correction process may perform the correction process that reduces the boundary area by performing an enlargement process on at least one of the front area and the side area within the boundary area that is a circular area (not limited to a true circular area) formed around the optical axis of the observation optical system (see FIG. 2),

This makes it possible to implement a correction process that reduces the boundary area having the shape illustrated in FIG. 2. The enlargement process performed on at least one of the front area and the side area may be implemented by outwardly enlarging the front area (see FIG. 15), or inwardly enlarging the side area (see FIG. 16). Note that the enlargement process may be performed on both the front area and the side area. It is possible to ensure smooth observation by reducing the boundary area.

The blending section 304 (boundary area correction section) that also performs the boundary area correction process may perform the enlargement process on the front area that has been subjected to the front chromatic-aberration-of-magnification correction process by the chromatic-aberration-of-magnification correction section 206, and may perform the enlargement process on the side area that has been subjected to the side chromatic-aberration-of-magnification correction process by the chromatic-aberration-of-magnification correction section 206.

This makes it possible for the blending section 304 to perform the enlargement process after the chromatic-aberration-of-magnification correction section 206 has performed the chromatic-aberration-of-magnification correction process. The R image signal, the G image signal, and the B image signal that should belong to identical coordinates belong to different coordinates before the chromatic-aberration-of-magnification correction process is performed. Therefore, if the enlargement process is performed before the chromatic-aberration-of-magnification correction process, the shift amount of each image signal (e.g., the shift amount of the R image signal and the B image signal with respect to the G image signal) changes. This makes it necessary to change the parameters used for the chromatic-aberration-of-magnification correction process. Therefore, it is desirable that the blending section 304 perform the enlargement process after the chromatic-aberration-of-magnification correction section 206 has performed the chromatic-aberration-of-magnification correction process.

The determination information storage section 402 may store the mask data that specifies the front area and the side area as the determination information.

This makes it possible to implement the area determination process using the mask data. The data illustrated in FIG. 6 may be used as the mask data. Since the mask data used as the determination information can be calculated in advance, it is possible to reduce the processing load during the determination process.

The chromatic-aberration-of-magnification correction section 206 may perform the side chromatic-aberration-of-magnification correction process on a circular area (not limited to a true circular area) formed around the optical axis of the side observation optical system that observes the side field of view.

This makes it possible to perform the side chromatic-aberration-of-magnification correction process on the circular side area (doughnut-shaped area) illustrated in FIG. 2.

The endoscopic image processing device may include the correction coefficient storage section 212 that stores the correction coefficients used for the chromatic-aberration-of-magnification correction process see FIG. 3).

This makes it possible to store the parameters used for the chromatic-aberration-of-magnification correction process as the correction coefficients. Since the correction coefficients stored in the correction coefficient storage section 212 are also determined by the design of the optical system, the correction coefficients can be calculated in advance in the same manner as the determination information stored in the determination information storage section 402. The processing load during the chromatic-aberration-of-magnification correction process can be reduced by providing the correction coefficient storage section 212, and storing the correction coefficients in the correction coefficient storage section 212.

The correction coefficient storage section 212 may store coefficients that determine the relationship between the square of the image height of an ith (i is an integer that satisfies “1≦i≦N”) color signal among first to Nth (N is an integer equal to or larger than two) color signals and the ratio of the image height of a k≠i, k is an integer that satisfies “1≦k≦N”) color signal to the image height of the ith color signal as the correction coefficients.

This makes it possible to store the coefficients αᵣ, βᵣ, γᵣ, α_{b}, β_{b}, and γ_{b} in the expressions (4) and (5) as the correction coefficients. In the first embodiment, the color signals consist of the R, G, and B image signals. The ith color signal corresponds to the G image signal, and the kth color signal corresponds to the R image signal and the B image signal. The square of the image height of the ith color signal corresponds to Q in the expression (1) (Q is the ratio of the square of the image height Xg to the square of the maximum image height Xmax). The ratio of the image height of the kth color signal to the image height of the ith color signal corresponds to Y(R) in the expression (2) and Y(B) in the expression (3).

The correction coefficient storage section 212 may store the front correction coefficients used for the front chromatic-aberration-of-magnification correction process as the correction coefficients, and may store the side correction coefficients used for the side chromatic-aberration-of-magnification correction process as the correction coefficients.

This makes it possible to store the front correction coefficients used for the front chromatic-aberration-of-magnification correction process and the side correction coefficients used for the side chromatic-aberration-of-magnification correction process as different values. Note that the front correction coefficients and the side correction coefficients may be identical values depending on the design of the optical system. The conditions of the front observation optical system and the conditions of the side observation optical system normally differ from each other. This applies to the ease where the endoscope apparatus includes the front observation optical system and the side observation optical system, and also the case where the endoscope apparatus acquires the front image and the side image in time series using a single optical system. Therefore, since it is necessary to change the correction coefficients used for the chromatic-aberration-of-magnification correction process depending on whether the front field of view or the side field of view is observed, it is desirable that the correction coefficient storage section 212 store the front correction coefficients and the side correction coefficients. More specifically, the correction coefficient storage section 212 may include the front correction coefficient storage section 305 and the side correction coefficient storage section 306 illustrated in FIG. 4.

The image acquisition section (e.g., A/D conversion section 204) may acquire the front image and the side image based on the image signals acquired by the image sensor. The image sensor may acquire the image signals using a method that corresponds to at least one imaging method among a Bayer imaging method, a two-chip imaging method, a three-chip imaging method, and a frame sequential imaging method.

This makes it possible to acquire the front image and the side image using a single-chip (Bayer) imaging method, a two-chip imaging method, or a frame sequential imaging method (see the second embodiment) instead of using a three-chip image sensor.

The chromatic-aberration-of-magnification correction section 206 may perform the front chromatic-aberration-of-magnification correction process on a circular area (not limited to a true circular area formed around the optical axis of the front observation optical system that observes the front field of view.

This makes it possible to perform the front chromatic-aberration-of-magnification correction process on the circular front area illustrated in FIG. 2.

The first embodiment also relates to an endoscopic image processing device that includes the age acquisition section (e.g., A/D conversion section 204) that acquires the front image that corresponds to the front field of view and the side image that corresponds to the side field of view, and the chromatic-aberration-of-magnification correction section 206 that performs a first chromatic-aberration-of-magnification correction process and a second chromatic-aberration-of-magnification correction process, the first chromatic-aberration-of-magnification correction process being the chromatic-aberration-of-magnification correction process performed on the front image, and the second chromatic-aberration-of-magnification correction process being the chromatic-aberration-of-magnification correction process performed on the side image.

This makes it possible to implement an endoscopic image processing device that acquires the front image and the side image, performs the front-image chromatic-aberration-of-magnification correction process on the front image, and performs the side-image chromatic-aberration-of-magnification correction process on the side image. Since the conditions of the optical system differ between the front image and the side image, a different chromatic-aberration-of-magnification correction process is required.

The first embodiment also relates to an endoscope apparatus that includes the endoscopic image processing device.

This makes it possible to implement an endoscope apparatus that includes the endoscopic image processing device according to the first embodiment. The field-of-view range can be increased by utilizing a wide-angle optical system that can observe the front field of view and the side field of view. This makes it possible to observe an area (e.g., the back side of folds) that is difficult to observe using a normal optical system, and easily find a lesion, for example. When using such a wide-angle optical system, it is necessary to change the chromatic-aberration-of-magnification correction process corresponding to the front area and the side area. It is possible to appropriately perform the chromatic-aberration-of-magnification correction process on each area by utilizing the method according to the first embodiment. When the blending section 304 also performs the boundary area correction process, it is possible to reduce the boundary area that may be erroneously determined to be folds during in vivo observation, This makes it possible to ensure smooth observation.

### 3. Second Embodiment

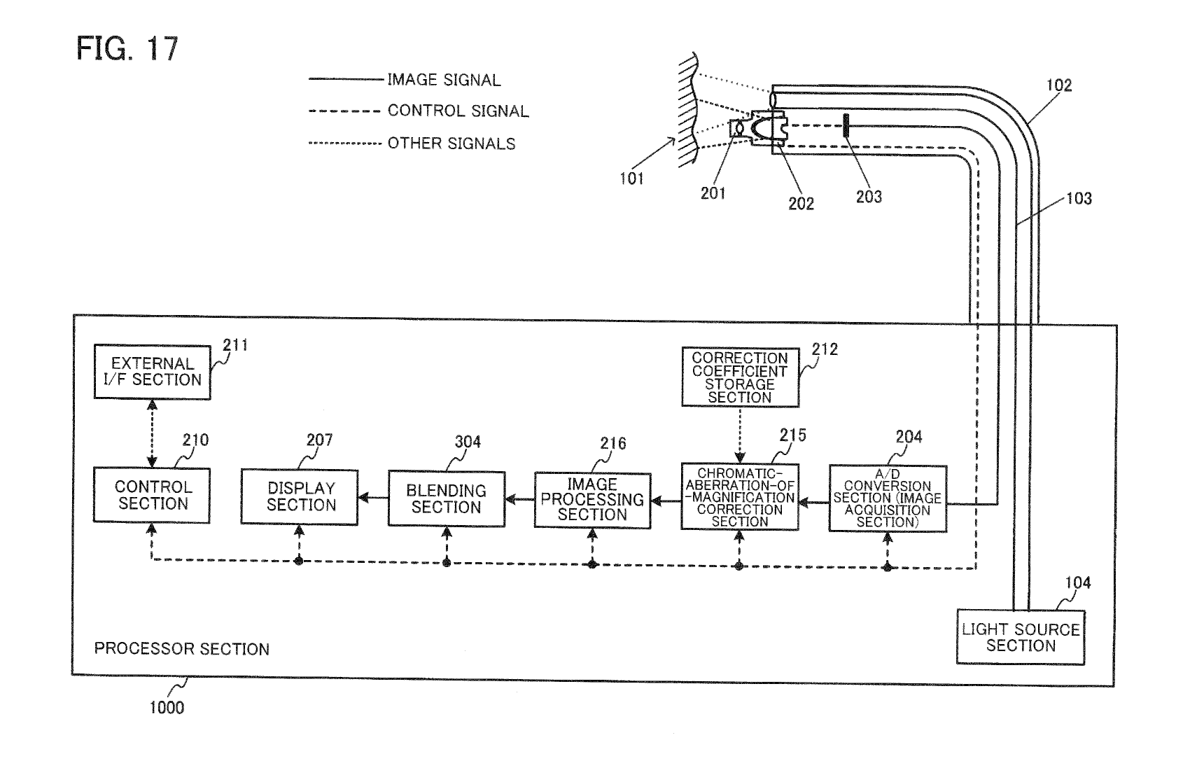

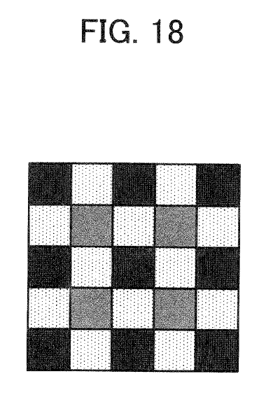

FIG. 17 illustrates a configuration example of an endoscope apparatus that includes an endoscopic image processing device according to the second embodiment. The endoscope apparatus illustrated in FIG. 17 includes an insertion section 102, a light guide 103, a light source section 104, a front observation optical system 201, a side observation optical system 202, an image sensor 203, an A/D conversion section 204, a chromatic-aberration-of-magnification correction section 215, an image processing section 216, a display section 207, a control section 210, an external I/F section 211, a blending section 304, and a correction coefficient storage section 212. A processor section 1000 includes the light source section 104, the A/D conversion section 204, the chromatic-aberration-of-magnification correction section 215, the image processing section 216, the display section 207, the control section 210, the external I/F section 211, the blending section 304, and the correction coefficient storage section 212. In the second embodiment, the image sensor 203 is a single-chip primary-color image sensor (see FIG. 18).

Note that the following description focuses on the differences from the first embodiment.

The A/D conversion section 204 is connected to the display section 207 via the chromatic-aberration-of-magnification correction section 215, the image processing section 216, and the blending section 304. The control section 210 is bidirectionally connected to the A/D conversion section 204, the chromatic-aberration-of-magnification correction section 215, the image processing section 216, the display section 207, the external I/F section 211, and the blending section 304.

The A/D conversion section 204 converts analog image signals output from the image sensor 203 into single-primary-color digital image signals (hereinafter referred to as “image signals”), and transmits the image signals to the chromatic-aberration-of-magnification correction section 215.

In the first embodiment, since the chromatic-aberration-of-magnification correction process is performed on the KGB image signals, the correction process is respectively performed on the R image signal and the B image signal on a pixel basis. In the second embodiment, since the chromatic-aberration-of-magnification correction process is performed on the single-primary-color mage signals, only one type of color image signal corresponds to each pixel. The front chromatic-aberration-of-magnification correction section 302 determines the type of the color image signal on a pixel basis under control of the control section 210. When the color image signal is the R image signal, the image height of the R image signal is calculated based on the ratio of the image height ratio of the R image signal to the image height of the G image signal, and the magnification shift amount is corrected by the interpolation process. When the color image signal is the B image signal, the image height of the B image signal is calculated based on the ratio of the image height ratio of the B image signal to the image height of the G image signal, and the magnification shift amount is corrected by the interpolation process. The chromatic-aberration-of-magnification correction process is not performed when the color image signal is the G image signal.

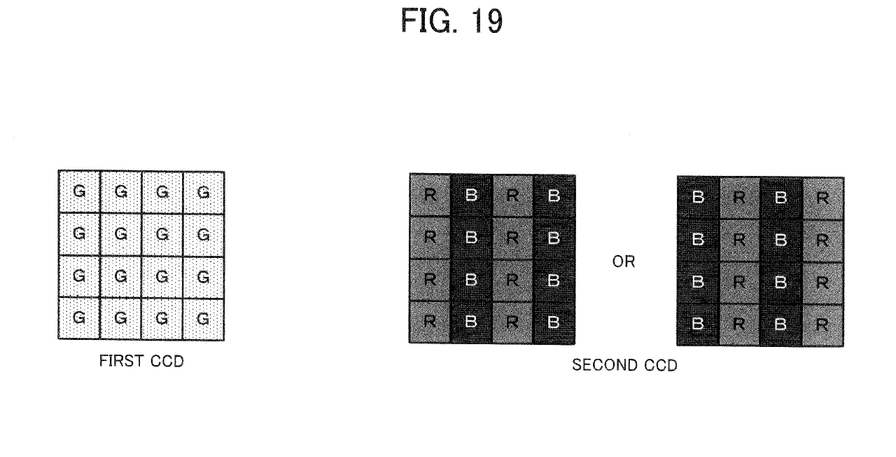

As a modification of the second embodiment, the image sensor 203 may be a two-chip primary-color image sensor (see FIG. 19). In this case, the front chromatic-aberration-of-magnification correction section 302 determines the type of the color image signal on a pixel basis corresponding to the channels formed by the R image signal and the B image signal under control of the control section 210. When the color image signal is the R image signal, the image height of the R image signal is calculated based on the ratio of the image height ratio of the R image signal to the image height of the G image signal, and the magnification shift amount is corrected by the interpolation process. When the color image signal is the B image signal, the image height of the B image signal is calculated based on the ratio of the image height ratio of the B image signal to the image height of the G image signal, and the magnification shift amount is corrected by the interpolation process. The chromatic-aberration-of-magnification correction process is not performed on the image signal corresponding to the channel formed by the G image signal.

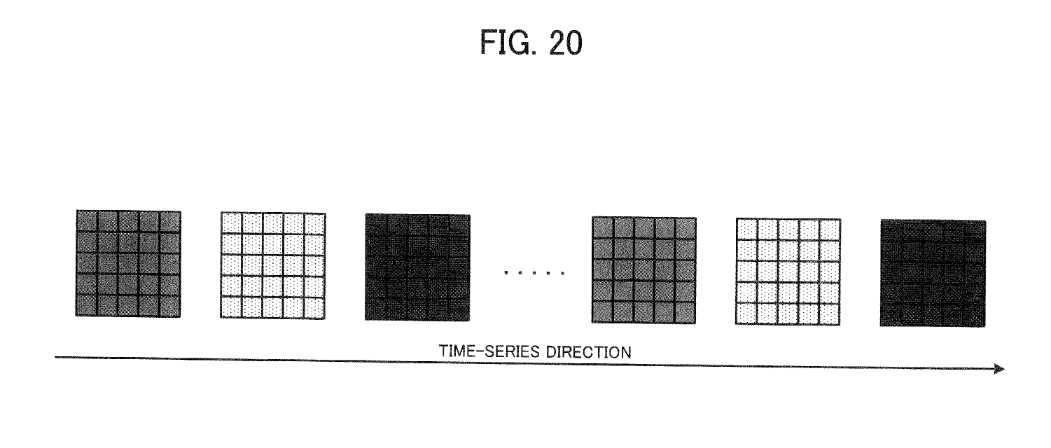

When the image sensor 203 is a frame-sequential image sensor (see FIG. 20), an R-channel image signal formed by the R image signal. a G-channel image signal formed by the G image signal, and a B-channel image signal formed by the B image signal are sequentially input in the time-series direction. In this case, when the image signal is the R-channel image signal, the image height of the R image signal is calculated on a pixel basis based on the ratio of the image height ratio of the R image signal to the image height of the G image signal, and the magnification shift amount is corrected by the interpolation process. When the image signal is the B-channel image signal, the image height of the B image signal is calculated on a pixel basis based on the ratio of the image height ratio of the B image signal to the image height of the G image signal, and the magnification shift amount is corrected by the interpolation process. The chromatic-aberration-of-magnification correction process is not performed on the G-channel image signal.

In the second embodiment, the chromatic-aberration-of-magnification correction process may be performed after correcting a shift (e.g., a shift that occurs during the production process) of the optical axis of the front observation optical system. In this case, the shift amount (px, py) of the optical axis of the front observation optical system is measured in advance, and stored in the front correction coefficient storage section 305.

In the second embodiment, the relative position calculation section 601 included in the front image height calculation section 501 extracts the coordinates (Xf, Yf) of the center point (i.e., a pixel that corresponds to the optical center of the front objective lens optical system) of the front area, and the shift amount (px, py) of the optical axis of the front observation optical system from the front correction coefficient storage section 305 under control of the control section 210. The relative position calculation section 601 calculates the relative position (posX, posY) of the attention pixel with respect to the optical center using the following expression (12), and transmits the relative position (posX, posY) to the square-of-image-height calculation section 602.

posX=i−Xf−px

posY=j−Yf−py (12)

Note that i is the horizontal coordinate value of the attention pixel, and j is the vertical coordinate value of the attention pixel.

The square-of-image-height calculation section 602 calculates the square Q of the image height of the G image signal (see the expression (1)) from the relative position (posX, posY) of the attention pixel and the radius Rf of a circle that corresponds to the front area (stored in the front correction coefficient storage section 305), and transmits the square Q to the image height ratio calculation section 603 under control of the control section 210. The image height ratio calculation section 603 extracts the image height ratio coefficient from the front correction coefficient storage section 305, calculates the ratio Y(R) of the image height of the R image signal using the expression (4), calculates the ratio Y(B) of the image height of the B image signal using the expression (5), and transmits the ratio Y(R) and the ratio Y(B) to the real image height calculation section 604 under control of the control section 210. The real image height calculation section 604 extracts the coordinates (Xf, Yf) of the center point (i.e., a pixel that corresponds to the optical center of the front objective lens optical system) of the front area from the front correction coefficient storage section 305, and calculates the converted coordinate values of the R image signal and the B image signal of the attention pixel using the following expressions (13) and (14).

RealX(R)=Y(R)×posX+Xf+px

RealY(R)=Y(R)×posY+Yf+py (13)

RealX(B)=Y(B)×posX+Xf+px

RealY(B)=Y(B)×posY+Yf+py (14)

Note that RealX(R) is the converted horizontal coordinate value of the R image signal of the attention pixel, RealY(R) is the converted vertical coordinate value of the R image signal of the attention pixel, RealX(B) is the converted horizontal coordinate value of the B image signal of the attention pixel, and RealY(B) is the converted vertical coordinate value of the B image signal of the attention pixel. The real image height calculation section 604 transmits the converted coordinate value information about the R image signal and the B image signal of the attention pixel to the front interpolation section 502.

The image processing section 216 performs known image processing on the single-primary-color image signals output from the chromatic-aberration-of-magnification correction section 215 under control of the control section 210. The image processing section 216 performs a single-primary-color/three-primary-color interpolation process, a white balance process, a color management process, a grayscale transformation process, and the like. The image processing section 216 transmits the resulting RGB signals to the display section 207.

Note that a shift of the optical axis of the side observation optical system may be corrected in the same manner as a shift of the optical axis of the front observation optical system. In this case, Xs and Ys must be used for the expressions (12) to (14) instead of Xf and Yf. The shift amount (px′, py′) of the optical axis of the side observation optical system is measured in advance, and px′ and py′ are used for the expressions (12) to (14) instead of px and py.

According to the second embodiment, the correction coefficient storage section 212 may store front optical axis shift correction coefficients used to correct a shift of the optical axis of the front observation optical system, and may store side optical axis shift correction coefficients used to correct a shift of the optical axis of the side observation optical system.

This makes it possible to correct a shift of the optical axis of the observation optical system, and then perform the chromatic-aberration-of-magnification correction process. Specifically, the image height is calculated based on the coordinate values that correspond to the optical center (see the expressions (6) to (8) or (12) to (14)). Therefore, when a shift of the optical axis has occurred. the chromatic-aberration-of-magnification correction process may be adversely affected if the shift of the optical axis is not appropriately corrected. According to the second embodiment, a shift (e.g., a shift that occurs during the production process) of the optical axis is stored in the correction coefficient storage section 212, and corrected when performing the chromatic-aberration-of-magnification correction process. More specifically, px and py (or px′ and py′ (side observation optical system)) in the expressions (12) to (14) are corrected. When the correction coefficient storage section 212 includes the front correction coefficient storage section 305 and the side correction coefficient storage section 306 (see FIG. 4), the front optical axis shift correction coefficients may be stored in the front correction coefficient storage section 305, and the side optical axis shift correction coefficients may be stored in the side correction coefficient storage section 306.

The first and second embodiments according to the invention and the modifications thereof have been described above. Note that the invention is not limited thereto. Various modifications and variations may be made without departing from the scope of the invention. A plurality of elements described in connection with the first and second embodiments and the modifications thereof may be appropriately combined to implement various configurations. For example, an arbitrary element may be omitted from the elements described in connection with the first and second embodiments and the modifications thereof. Some of the elements disclosed in connection with different embodiments or modifications thereof may be appropriately combined. Specifically, various modifications and applications are possible without materially departing from the novel teachings and advantages of the invention.

What is claimed is:

1. An endoscopic image processing device comprising:
an image acquisition section that acquires a front image that corresponds to a front field of view and a side image that corresponds to a side field of view; and
a chromatic-aberration-of-magnification correction section that performs a chromatic-aberration-of-magnification correction process on an observation optical system,
the chromatic-aberration-of-magnification correction section determining whether a processing target image signal corresponds to the front field of view or the side field of view, and performing a front chromatic-aberration-of-magnification correction process as the chromatic-aberration-of-magnification correction process when the chromatic-aberration-of-magnification correction section has determined that the processing target image signal corresponds to the front field of view.

2. The endoscopic image processing device as defined in claim 1,
the chromatic-aberration-of-magnification correction section performing aside chromatic-aberration-of-magnification correction process as the chromatic-aberration-of-magnification correction process when the chromatic-aberration-of-magnification correction section has determined that the processing target image signal corresponds to the side field of view.

3. The endoscopic image processing device as defined in claim 2,
the image acquisition section acquiring image signals that form the front image and the side image as a single image, and
the chromatic-aberration-of-magnification correction section including a determination information storage section that stores determination information that is used to determine whether the processing target image signal corresponds to the front field of view or the side field of view within the single image.

4. The endoscopic image processing device as defined in claim 3, further comprising:
a boundary area correction section that performs a correction process that reduces a boundary area that forms a boundary between a front area and a side area, the front area being an area that corresponds to the front field of view within the single image, and the side area being an area that corresponds to the side field of view within the single image.

5. The endoscopic image processing device as defined in claim 4,
the boundary area correction section performing the correction process that reduces the boundary area by performing an enlargement process on at least one of the front area and the side area within the boundary area that is a circular area formed around an optical axis of the observation optical system.

6. The endoscopic image processing device as defined in claim 5,
the boundary area correction section performing the enlargement process on the front area that has been subjected to the front chromatic-aberration-of-magnification correction process by the chromatic-aberration-of-magnification correction section.

7. The endoscopic image processing device as defined in claim 5,
the boundary area correction section performing the enlargement process on the side area that has been subjected to the side chromatic-aberration-of-magnification correction process by the chromatic-aberration-of-magnification correction section.

8. The endoscopic image processing device as defined in claim 3,
the determination information storage section storing mask data that specifies a front area and a side area as the determination information, the front area being an area that corresponds to the front field of view within the single image, and the side area being an area that corresponds to the side field of view within the single image.

9. The endoscopic image processing device as defined in claim 2,
the chromatic-aberration-of-magnification correction section performing the side chromatic-aberration-of-magnification correction process on a circular area formed around an optical axis of the observation optical system that observes the side field of view.

10. The endoscopic image processing device as defined in claim 1, further comprising:
a correction coefficient storage section that stores correction coefficients used for the chromatic-aberration-of-magnification correction process.

11. The endoscopic image processing device as defined in claim 10,
the correction coefficient storage section storing coefficients that determine a relationship between a square of an image height of an ith (i is an integer that satisfies “1≦i≦N”) color signal among first to Nth (N is an integer equal to or larger than two) color signals and a ratio of an image height of a kth (k≠i, k is an integer that satisfies “1≦k≦N”) color signal to the image height of the ith color signal as the correction coefficients.

12. The endoscopic image processing device as defined in claim 10,
the correction coefficient storage section storing front correction coefficients used for the front chromatic-aberration-of-magnification correction process as the correction coefficients.

13. The endoscopic image processing device as defined in claim 10,
the chromatic-aberration-of-magnification correction section performing a side chromatic-aberration-of-magnification correction process as the chromatic-aberration-of-magnification correction process when the chromatic-aberration-of-magnification correction section has determined that the processing target image signal corresponds to the side field of view, and
the correction coefficient storage section storing side correction coefficients used for the side chromatic-aberration-of-magnification correction process as the correction coefficients.

14. The endoscopic image processing device as defined in claim 1,
the image acquisition section acquiring the front image and the side image based on image signals acquired by an image sensor, and
the image sensor acquiring the image signals using a method that corresponds to at least one imaging method among a Bayer imaging method, a two-chip imaging method, a three-chip imaging method, and a frame sequential imaging method.

15. The endoscopic image processing device as defined in claim 1,
the chromatic-aberration-of-magnification correction section performing the front chromatic-aberration-of-magnification correction process on a circular area formed around an optical axis of the observation optical system that observes the front field of view.

16. The endoscopic image processing device as defined in claim 15, further comprising:
a correction coefficient storage section that stores correction coefficients used for the chromatic-aberration-of-magnification correction process,
the correction coefficient storage section storing front optical axis shift correction coefficients used to correct a shift of the optical axis of the observation optical system that observes the front field of view.

17. The endoscopic image processing device as defined in claim 9, further comprising:
a correction coefficient storage section that stores correction coefficients used for the chromatic-aberration-of-magnification correction process,
the correction coefficient storage section storing side optical axis shift correction coefficients used to correct a shift of the optical axis of the observation optical system that observes the side field of view.

18. An endoscopic image processing device comprising:
an image acquisition section that acquires a front image that corresponds to a front field of view and a side image that corresponds to a side field of view; and
a chromatic-aberration-of-magnification correction section that performs a first chromatic-aberration-of-magnification correction process and a second chromatic-aberration-of-magnification correction process, the first chromatic-aberration-of-magnification correction process being performed on the front image, and the second chromatic-aberration-of-magnification correction process being performed on the side image.

19. An endoscope apparatus comprising the endoscopic image processing device as defined in claim 1.

20. An endoscope apparatus comprising the endoscopic image processing device as defined in claim 18.

21. An image processing method comprising:
acquiring a front image that corresponds to a front field of view and a side image that corresponds to a side field of view;
determining whether a processing target image signal corresponds to the front field of view or the side field of view; and
performing a front chromatic-aberration-of-magnification correction process as a chromatic-aberration-of-magnification correction process on an observation optical system when it has been determined that the processing target image signal corresponds to the front field of view.
